(19) United States
(12) Patent Application Publication
(10) Pub. No.: US 2002/0055845 A1
(43) Pub. Date: May 9, 2002

(54) Voice processing apparatus, voice processing method and memory medium

(76) Inventors: Takaya Ueda, Kanagawa (JP); Yuji Ikeda, Kanagawa (JP); Tetsuo Kosaka, Kanagawa (JP); Shigeki Shibayama, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/970,986

(22) Filed: Oct. 5, 2001

(30) Foreign Application Priority Data
Oct. 11, 2000 (JP) 2000-311097

(51) Int. Cl. G10L 21/00; G10L 11/00

(52) U.S. Cl. 704/270

(57) ABSTRACT

The invention is to achieve highly precise voice recognition in efficient manner utilizing plural voice recognition apparatuses connected to a network. A communication terminal device executes voice recognition on the voice of the user, utilizing highly precise plural voice recognition apparatuses connected to a network. Then the communication terminal device compares the scores of the results of recognition obtained respectively from the voice recognition apparatuses and selects one of the results.

### BACKGROUND OF THE INVENTION

1. Field of the Invention

The present invention relates to a voice processing apparatus, a voice processing method and a memory medium therefor, utilizing plural voice recognition apparatus connected to a network.

2. Related Background Art

Recently there is practiced a technology for recognizing the voice of a person on an electronic computer according to a predetermined rule (so-called voice recognition technology). Also recently there is being developed a technology for entering commands and character information, that have been manually entered into the computer, by voice utilizing such voice recognition technology.

However, since the voice recognition process involves a relatively large amount of calculation, there is required an expensive high-performance computer in order to recognize all the voices of the user on real time basis. It has therefore been difficult to apply such voice recognition to an inexpensive compact portable terminal device such as a mobile computer or a portable telephone.

### SUMMARY OF THE INVENTION

In consideration of the foregoing, the object of the present invention is to efficiently achieve highly precise voice recognition utilizing plural voice recognition apparatus connected to a network. The above-mentioned object can be attained, according to an embodiment of the present invention, by a voice processing apparatus comprising voice input means for entering voice, voice recognition means for recognizing the voice entered by the voice input means, discrimination means for discriminating the confidence of the result of recognition obtained by the voice recognition means, transmission means for transmitting the entered voice to external plural voice recognition apparatus in case the discrimination means identifies that the confidence is smaller than a predetermined value, and selection means for selecting the result of recognition obtained from one of the plural voice recognition apparatus based on the plural reliabilities obtained from the plural voice recognition apparatus.

### BRIEF DESCRIPTION OF THE DRAWINGS

FIG. 1 is a view showing the configuration of a voice recognition system concerning a first embodiment;

FIG. 2 is a block diagram showing the configuration of a communication terminal device concerning the first embodiment;

FIG. 3 is a flow chart showing the voice recognition procedure for input voice by the communication terminal device concerning the first embodiment; and

FIG. 4 is a flow chart showing the voice recognition procedure for input voice by the communication terminal device concerning a second embodiment.

### DESCRIPTION OF THE PREFERRED EMBODIMENTS

### First Embodiment

In the following a first embodiment of the present invention will be explained in detail with reference to the accompanying drawings.

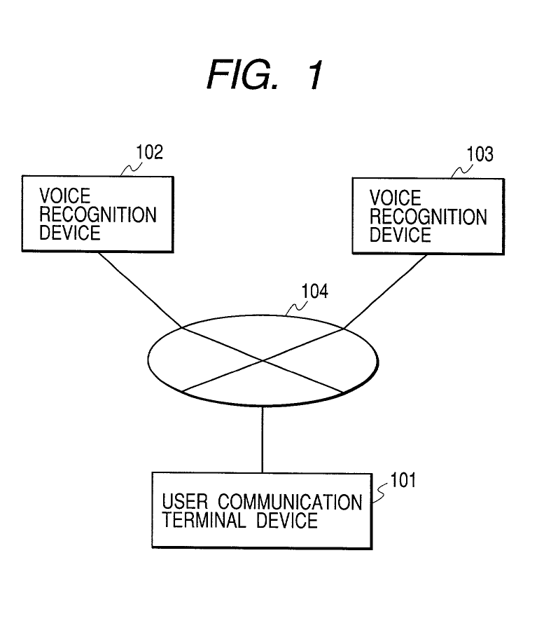

FIG. 1 is a view showing the basic configuration of a voice recognition system concerning the present embodiment.

Referring to FIG. 1, there are provided a communication terminal device 101 such as a mobile computer or a portable telephone, incorporating a voice recognition program having a small vocabulary dictionary, voice recognition apparatus 102, 103 having large vocabulary dictionaries, based on respectively different grammar rules, and a network 104 such as internet or a mobile member communication network.

The communication terminal device 101 is an inexpensive and simple voice recognition apparatus with a limited amount of calculation, having a function of simple voice recognition of simple short words such as “return” or “go”. On the other hand, the voice recognition apparatuses 102, 103 are expensive and highly precise voice recognition apparatuses with a large amount of calculation, having a function of highly precise voice recognition for a long and complex sentence such as a name or an address. In the voice recognition system of the present embodiment, the function of voice recognition is dispersed to constitute the information terminal device without sacrificing the efficiency of recognition, thereby improving the convenience and portability for the user.

The communication terminal device 101 and the voice recognition apparatuses 102, 103 are capable of mutual data communication through the network 104. The voice of the user entered into the communication terminal device 101 is transmitted to each of the voice recognition apparatuses 102, 103, which recognize the voice from the communication terminal device 101 and return a character train and a score, obtained by the voice recognition, to the communication terminal device 101.

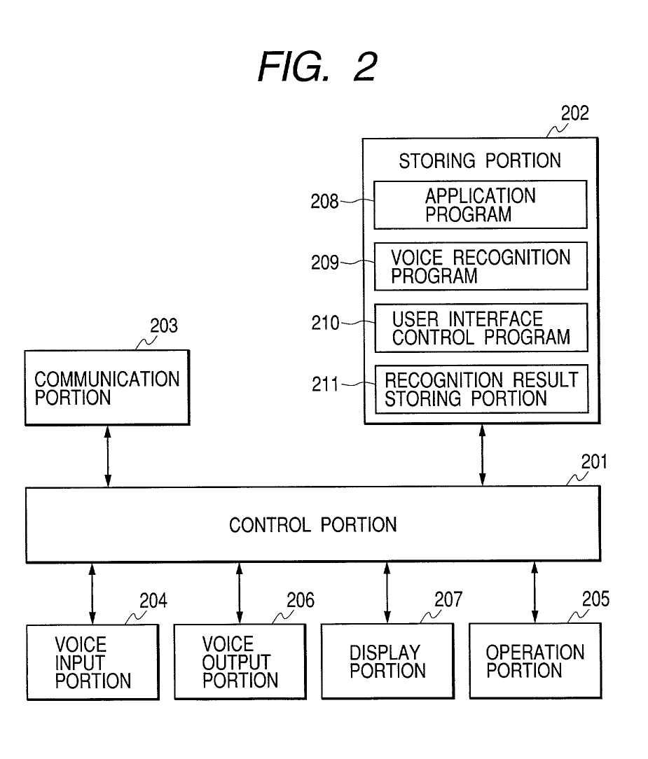

Now reference is made to FIG. 2 for explaining the configuration of the communication terminal device 101 concerning the first embodiment.

Referring to FIG. 2, there are shown a control portion 201, a storing portion 202, a communication portion 203, a voice input portion 204, an operation portion 205, a voice output portion 206, and a display portion 207. There are also shown an application program 208, a voice recognition program 209, a user interface control program 210, and a recognition result storing portion 211.

The control portion 201 is composed of a work memory, a microcomputer etc., reads the application program 208, the voice recognition program 209 and the user interface control program 210 stored in the storage portion 202 and executes such programs.

The storage portion 202 is composed of a storage medium such as a magnetic disk, an optical disk or a hard disk and stores the application program 208, the voice recognition program 209, the user interface control program 201 and the recognition result storage portion 211 in predetermined areas. The communication portion 203 executes data communication with the voice recognition apparatuses 102, 103 connected to the network 104.

The voice input portion 204 is composed for example of a microphone, and enters the voice emitted by the user. The operation portion 205 is composed of a keyboard, a mouse, a touch panel, a joystick, a pen and a tablet etc., and operates a graphical user interface of the application program 208.

The voice output portion 206 is composed of a speaker, a headphone etc. The display portion 207 is composed of a display device such as a liquid crystal display, and displays the graphical user interface of the application programs 208, 212.

The application program 208 has a web browser function for browsing the information (web contents such as home pages and various data files) on the network 104 and a graphical user interface for operating such function. The voice recognition program 209 has a function of recognizing simple and short words such as “stop”, “back”, “forward” etc.

The user interface control program 210 converts the character train obtained through voice recognition by the voice recognition program 209 into a predetermined command for entry into the application program 208, and enters one of the character trains obtained through the voice recognition by the voice recognition apparatuses 102, 103 into the application program 208. The recognition result storage portion 211 stores the character train and the score obtained by voice recognition in the voice recognition apparatuses 102, 103.

In the present embodiment, the score means confidence (or likelihood) of the character train obtained by voice recognition in the voice recognition apparatuses 102, 103. The score becomes higher or lower respectively if almost all the portions of a phrase contained in the voice of the user can be correctly recognized or not according to the large vocabulary dictionary and the grammar rule adopted by the voice recognition apparatuses 102, 103.

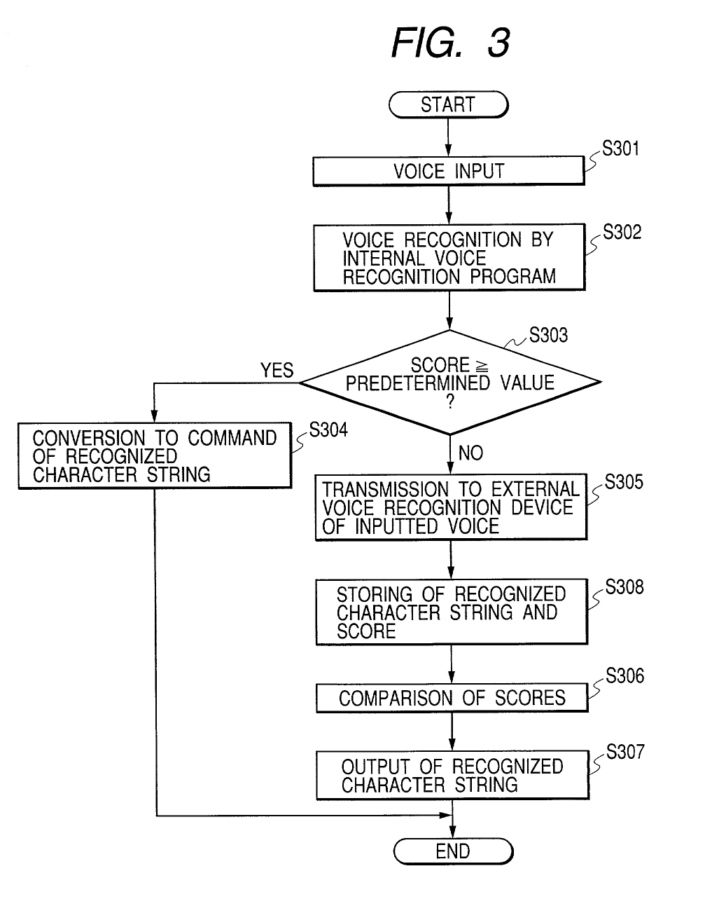

In the following there will be explained, with reference to FIG. 3, the procedure of voice recognition for the input voice by the communication terminal device 101 of the first embodiment, utilizing the voice recognition apparatuses 102, 103 connected to the network 104. This procedure is executed by the control portion 201 according to the user interface control program 210 stored in the storage portion 202.

In a step S301, the control portion 201 enters the voice of the user, entered into the voice input portion 204, into the voice recognition program 209.

In a step S302, the control portion 201 executes voice recognition on the voice entered in the step S301, utilizing the voice recognition program 209 stored in the storage portion 202.

In a step S303, the control portion 201 discriminates whether the score of the character train obtained by voice recognition according to the voice recognition program 209 is equal to or larger than a predetermined value. In case the score is equal to or larger than the predetermined value, the recognition is judged as properly executed and the sequence proceeds to a step S304. In case the score is smaller than the predetermined value, the recognition is judged as not properly executed and the sequence proceeds to a step S305.

In a step S304, the control portion 201 converts the character train obtained by the voice recognition program 209 into a predetermined command and enters the converted command into the application program 208. For example a character train “return” is converted into a command for returning from the currently viewed page to a preceding page, and a character train “go” is converted into a command for proceeding from the currently viewed page to a next page. The application program 208 executes a process corresponding to the entered command and displays the result of execution on the display portion 207.

On the other hand, in a step S305, the control portion 201 transmits the voice, entered in the step S301, to each of the voice recognition apparatuses 102, 103 connected to the network 104. The voice recognition apparatuses 102, 103 execute voice recognition on the voice transmitted from the communication terminal device 101 and return the character train and the score, obtained by voice recognition, to the communication terminal device 101. In a step S308, the character train and the score returned from the voice recognition apparatuses 102, 103 within a predetermined period are stored in the recognition result storage portion 211. As explained in the foregoing, by utilizing the external voice recognition apparatuses 102, 103 for voice recognition on the voice what is judged as not properly recognizable by the voice recognition program 209 in the communication terminal device 101, there can be improved the efficiency of recognition by the communication terminal device to be provided to the user.

In a step S306, the control portion 201 compares the scores of the character trains stored in the recognition result storage portion 211 and selects a character train corresponding to the highest score. As an example, there will be explained a case where the voice entered in the step S301 is “Kawasaki Shi, Nakahara Ku, Imainoue Cho”. If the character train obtained in the voice recognition apparatus 102 is “Kawasaki” with a score of “0, 3” while the character train obtained in the voice recognition apparatus 103 is “Kawasaki Shi, Nakahara Ku, Imainoue Cho” with a score of “0, 9”, there is selected the latter character train obtained in the voice recognition apparatus 103.

In a step S307, the control portion 201 enters the character train, selected in the step S306, into the application program 208. The application program 208 outputs the entered character train in a preselected input field of the graphical user interface displayed on the display portion 207.

In the first embodiment, as explained in the foregoing, the inexpensive simple voice recognition involving a smaller amount of processing is executed by the communication terminal device to be provided to the user while the expensive and highly precise voice recognition involving a larger amount of processing is executed by the plural voice recognition apparatuses connected to the network, whereby the communication terminal apparatus to be provided to the user can be constructed inexpensively without sacrificing the efficiency of recognition.

Also according to the first embodiment, the efficiency of recognition of the information terminal device to be provided to the user can be further improved since there are utilized a plurality of highly precise voice recognition apparatuses based on different grammar rules and vocabulary dictionaries. Also the user can utilize the highly advanced voice recognition system in a very simple manner, since the user can automatically obtain the optimum recognition even in case of using a plurality of the voice recognition apparatuses, without noticing the mode of such use. Also the first embodiment allows to reduce the cumbersome manual operations since the user can automatically obtain the optimum recognition result even in case of using a plurality of the voice recognition apparatuses. Furthermore, the communication terminal device to be provided to the user can be made compact since there is not required an exclusive operation button or the like. In particular it is possible to improve the convenience of use and the portability of the portable terminal device in case of application to a mobile computer or a portable telephone.

In the first embodiment, there has been explained a case of constructing the voice recognition system with the two voice recognition apparatuses 102, 103 connected to the network 104, but the present invention is not limited to such configuration and the voice recognition system may be constructed with three or more voice recognition apparatuses.

Also in the first embodiment, there has only been explained a case of simply comparing the scores of the recognition results obtained in the voice recognition apparatuses 102 and 103, but the present invention is not limited to such configuration and the comparison may be made after predetermined weighting to each score.

Also in the first embodiment, there has been explained a case of executing the voice recognition of the input voice by all the voice recognition apparatuses connected to the network 104, but the present invention is not limited to such configuration. In case M voice recognition apparatuses are connected to the network 104 (M being an integer equal to or larger than 2), the voice recognition of the input voice may be executed by N voice recognition apparatus (N being an integer equal to or larger than 1) positioned close to the communication terminal device 101 or by N voice recognition apparatus (N being an integer equal to or larger than 1) with a low load of processing.

Also in the first embodiment, there has been explained a case of executing the voice recognition of the input voice by all the voice recognition apparatuses connected to the network 104, but the present invention is not limited to such configuration. In case M voice recognition apparatuses are connected to the network 104 (M being an integer equal to or larger than 2), it is also possible to record the history of selection of the recognition results of the voice recognition apparatuses and the voice recognition of the input voice may be executed by N voice recognition apparatus (N being an integer equal to or larger than 1) having the highest results of recent utilization or by N voice recognition apparatus (N being an integer equal to or larger than 1) having the highest number of utilization.

### Second Embodiment

In the following there will be explained in detail a second embodiment of the present invention with reference to FIGS. 1, 2 and 4.

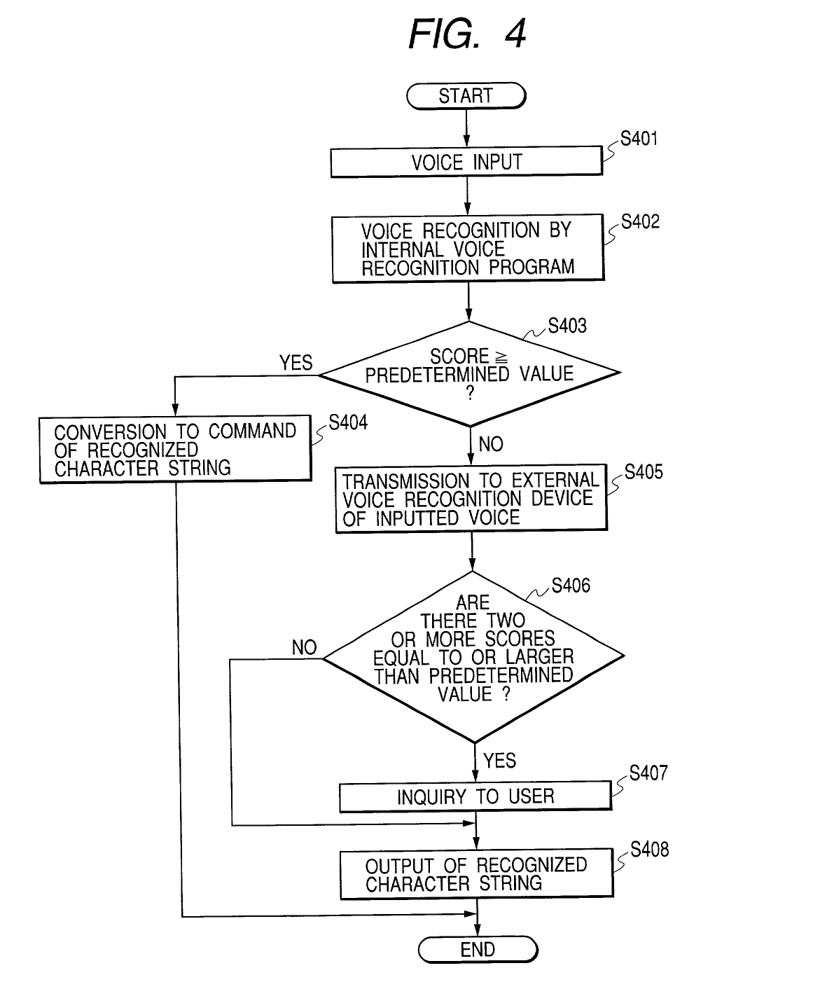

Now reference is made to FIG. 4 for explaining the procedure which the communication terminal device 101 concerning the second embodiment executes for voice recognition of the input voice utilizing the voice recognition apparatuses 102, 103 connected to the network 104. This procedure is executed by the control portion 201 according to the user interface control program 210 stored in the storage portion 202.

In a step S401, the control portion 201 enters the voice of the user, entered into the voice input portion 204, into the voice recognition program 209.

In a step S402, the control portion 201 executes voice recognition on the voice entered in the step S301, utilizing the voice recognition program 209 stored in the storage portion 202.

In a step S403, the control portion 201 discriminates whether the score of the character train obtained by voice recognition according to the voice recognition program 209 is at least equal to a predetermined value. In case the score is equal to or larger than the predetermined value, the recognition is judged as properly executed and the sequence proceeds to a step S404. In case the score is smaller than the predetermined value, the recognition is judged as not properly executed and the sequence proceeds to a step S405.

In a step S404, the control portion 201 converts the character train obtained by the voice recognition program 209 into a predetermined command and enters the converted command into the application program 208. For example a character train “return” is converted into a command for returning from the currently viewed page to a preceding page, and a character train “go” is converted into a command for proceeding from the currently viewed page to a next page. The application program 208 executes a process corresponding to the entered command and displays the result of execution on the display portion 207.

On the other hand, in a step S405, the control portion 201 transmits the voice, entered in the step S401, to each of the voice recognition apparatuses 102, 103 connected to the network 104. The voice recognition apparatuses 102, 103 execute voice recognition on the voice transmitted from the communication terminal device 101 and return the character train and the score, obtained by voice recognition, to the communication terminal device 101. The character train and the score returned from the voice recognition apparatuses 102, 103 within a predetermined period are stored in the recognition result storage portion 211. As explained in the foregoing, by utilizing the external voice recognition apparatuses 102, 103 for voice recognition on the voice what is judged as not properly recognizable by the voice recognition program 209 in the communication terminal device 101, there can be improved the efficiency of recognition by the communication terminal device to be provided to the user.

In a step S406, the control portion 201 detects character trains corresponding to the scores equal to or larger than the predetermined value, among the character trains stored in the recognition result storage portion 211. Then the sequence proceeds to a step S407 in case there are plural character trains having scores equal to or larger than the predetermined value, but to a step S408 in case there is only one character train having the score equal to or larger than the predetermined value. As an example, there will be explained a case where the voice entered in the step S401 is “Kawasaki Shi, Nakahara Ku, Imainoue Cho”. If the character train obtained in the voice recognition apparatus 102 is “Kawasaki Shi, Nakahara Ku, Imainoue Cho” with a score of “0, 9” while the character train obtained in the voice recognition apparatus 103 is “Kawasaki Shi, Nakahara Ku, Imainoue Cho” with a score of “0, 9”, while the predetermined value is “0, 9”, the sequence proceeds to the step S407 since there are two character trains with scores equal to or larger than the predetermined value.

In a step S407, the control portion 201 informs the user of the character trains detected in the step S406, in the order of scores, on the display portion 207. Such information in the order of the scores improves the operability of the user.

The user selects, by the operation portion 205 or the voice input portion 204, one of the candidates of selection informed by display or by voice in the order of the scores. Such configuration allows to always select the proper result even in case there are plural character trains corresponding to the scores equal to or larger than the predetermined value.

In a step S408, the control portion 201 enters the character train detected in the step S408 or in the step S407 into the application program 208. The application program 208 outputs the entered character train in a preselected input field of the graphical user interface display on the display portion 207.

As explained in the foregoing and as in the first embodiment, in the second embodiment, the inexpensive simple voice recognition involving a smaller amount of processing is executed by the communication terminal device to be provided to the user while the expensive and highly precise voice recognition involving a larger amount of processing is executed by the plural voice recognition apparatuses connected to the network, whereby the communication terminal apparatus to be provided to the user can be constructed inexpensively without sacrificing the efficiency of recognition.

Also according to the second embodiment, the efficiency of recognition of the information terminal device to be provided to the user can be further improved since there are utilized a plurality of highly precise voice recognition apparatuses based on different grammar rules and vocabulary dictionaries. Also the user can utilize the highly advanced voice recognition system in a very simple manner, since the user can automatically obtain the optimum recognition even in case of using a plurality of the voice recognition apparatuses, without noticing the mode of such use. Also, in case the results of recognition obtained by the plural voice recognition apparatuses are equal to or larger than the predetermined value, these results of recognition are selected by the user, so that a correct result can always be selected.

In the second embodiment, there has been explained a case of constructing the voice recognition system with the two voice recognition apparatuses 102, 103 connected to the network 104, but the present invention is not limited to such configuration and the voice recognition system may be constructed with three or more voice recognition apparatuses.

Also in the second embodiment, there has only been explained a case of simply comparing the scores of the recognition results obtained in the voice recognition apparatuses 102 and 103, but the present invention is not limited to such configuration and the comparison may be made after predetermined weighting to each score.

Also in the second embodiment, there has been explained a case of causing the user to select one of the results of recognition obtained in the voice recognition apparatuses 102, 103 in case both results are equal to or larger than the predetermined value, but the present invention is not limited to such configuration. It is also possible, for example, to set priorities to the voice recognition apparatuses 102, 103 and to automatically select a result of recognition according to such priorities.

Also in the second embodiment, there has been explained a case of causing the user to select one of the results of recognition obtained in the voice recognition apparatuses 102, 103 in case both results are equal to or larger than the predetermined value, but the present invention is not limited to such configuration. For example it is also possible to record the history of selection of the recognition results of the voice recognition apparatuses and to automatically select a result of recognition based on such history. Also in the second embodiment, there has been explained a case of executing voice recognition on the input voice utilizing all the voice recognition apparatuses connected to the network, but the present invention is not limited to such configuration. In case M voice recognition apparatuses are connected to the network 104 (M being an integer equal to or larger than 2), the voice recognition of the input voice may be executed by N voice recognition apparatus (N being an integer equal to or larger than 1) positioned close to the communication terminal device 101 or by N voice recognition apparatus (N being an integer equal to or larger than 1) with a low load of processing.

Also in the second embodiment, there has been explained a case of executing the voice recognition of the input voice by all the voice recognition apparatuses connected to the network 104, but the present invention is not limited to such configuration. In case M voice recognition apparatuses are connected to the network 104 (M being an integer equal to or larger than 2), it is also possible to record the history of selection of the recognition results of the voice recognition apparatuses and the voice recognition of the input voice may be executed by N voice recognition apparatus (N being an integer equal to or larger than 1) having the highest results of recent utilization or by N voice recognition apparatus (N being an integer equal to or larger than 1) having the highest number of utilization.

### Other Embodiments

The present invention is not limited to the foregoing embodiments but may be realized in various forms.

For example, the present invention is also applicable to a case where an OS (operating system) or the like functioning on the control portion 201 executes all the processes of the aforementioned embodiments or a part thereof under the instructions of the user interface control program 210 read by the control portion 201.

The present invention also includes a case where the user interface control program 210 read from the memory portion 202 is written into a memory provided in a function expansion unit connected to the information terminal device 101 and a control portion or the like provided in the function expansion unit executes all the processes or a part thereof under the instructions of the program 210 whereby the functions of the aforementioned embodiments are realized.

As explained in the foregoing, the present invention allows to achieve highly precise voice recognition, utilizing plural voice recognition apparatuses connected to the network.

What is claimed is:

1. A voice processing apparatus comprising:
voice input means for entering voice;
transmission means for transmitting the voice entered by said voice input means to external plural voice recognition apparatuses; and
selection means for selecting a result of recognition obtained from one of said plural voice recognition apparatuses, based on the plural reliabilities obtained from said plural voice recognition apparatuses.

2. An apparatus according to claim 1, further comprising:
voice recognition means for executing voice recognition on the voice entered by said voice input means; and
discrimination means for discriminating the confidence of the result of recognition obtained by said voice recognition means, wherein said selection means is selected in case said discrimination means identifies that the confidence is equal to or larger than the predetermined value.

3. An apparatus according to claim 1, wherein at least one of said plural voice recognition apparatuses has a grammar rule different from that of other voice recognition apparatuses.

4. An apparatus according to claim 1, further comprising reception means for receiving the reliabilities obtained from said plural voice recognition apparatuses.

5. An apparatus according to claim 1, further comprising:
informing means for informing the user of plural results of recognition in case such plural results of recognition have reliabilities equal to or larger than a predetermined value;
wherein selected is a result of recognition selected by the user from the plural results of recognition informed by said informing means.

6. A voice processing method comprising:
a voice input step of entering voice;
a transmission step of transmitting the voice entered by said voice input means to external plural voice recognition apparatuses in case said discrimination step identifies that the confidence is less than a predetermined value; and
a selection step of selecting a result of recognition obtained from one of said plural voice recognition apparatuses, based on the plural reliabilities obtained from said plural voice recognition apparatuses.

7. A method according to claim 6, further comprising:
a voice recognition step of executing voice recognition on the voice entered by said voice input step; and
a discrimination step of discriminating the confidence of the result of recognition obtained by said voice recognition step, wherein said selection step is selected in case said discrimination step identifies that the confidence is equal to or larger than the predetermined value.

8. A method according to claim 6, wherein at least one of said plural voice recognition apparatuses has a grammar rule different from that of other voice recognition apparatuses.

9. A method according to claim 6, further comprising a reception step of receiving the reliabilities obtained from said plural voice recognition apparatuses.

10. A method according to claim 6, further comprising:
an informing step of informing the user of plural results of recognition in case such plural results of recognition have reliabilities equal to or larger than a predetermined value;
wherein selected is a result of recognition selected by the user from the plural results of recognition informed by said informing step.

11. A memory medium storing a program for executing a voice processing method according to any of claims 6 to 10.
